(19) United States
(12) Patent Application Publication
(10) Pub. No.: US 2026/0258286 A1
(43) Pub. Date: Sep. 3, 2026

(54) RELEASE COATING WITH LOW FRICTION COEFFICIENT

(71) Applicant: tesa SE, Norderstedt (DE)

(72) Inventors: Andreas Wieck, Halstenbek (DE); Sven Reiter, Norderstedt (DE)

(73) Assignee: tesa SE, Norderstedt (DE)

(21) Appl. No.: 18/996,775

(22) PCT Filed: Jul. 5, 2023
(86) PCT No.: PCT/EP2023/068527

§ 371 Date: Jan. 17, 2025

(30) Foreign Application Priority Data
Jul. 20, 2022 (DE) 102022118173.1

(51) Int. Cl. C09J 7/40

(52) U.S. Cl. CPC C09J 7/401; C09J 2301/302; C09J 2401/005; C09J 2403/005; C09J 2483/005

(57) ABSTRACT

The invention concerns a release coating for furnishing a release liner, comprising ⋅ a release agent and ⋅ 0.01% to 30% by weight, based on the total weight of the release coating, of three-dimensional elements K and being characterized in that the elements K contain in total at least 90% by weight of one or more polysaccharides. The invention further concerns the use of such a release coating in release liners or on reverse sides of adhesive-tape carriers and also release liners equipped therewith and the use thereof in adhesive tapes.

### CROSS-REFERENCE TO RELATED APPLICATION

This application is a United States national stage application under 35 U.S.C. § 371 that claims the benefit of priority under 35 U.S.C. § 365 of International Patent Application No. PCT/EP2023/068527, filed on 5 Jul. 2023, designating the United States of America, which in turn claims the benefit of priority under 35 U.S.C. §§ 119, 365 of German Patent Application No. 102022118173.1, filed 20 Jul. 2022, the contents of which are relied upon and incorporated herein by reference in their entirety.

### TECHNICAL FIELD

The invention relates to the technical field of release coatings, as they are used as non-stick coatings for release liners or back sides of adhesive tape. The invention more specifically proposes a release coating which has a low coefficient of friction.

### BACKGROUND

At the end of the production process, adhesive tapes, coated on one or both sides with adhesives, are usually wound up into a roll in the form of an Archimedean spiral. To prevent the pressure-sensitive adhesives coming into contact with one another in the case of double-sided adhesive tapes, or to ensure greater ease of unwind in the case of single-sided adhesive tapes, the adhesive is covered with a liner material (also referred to as release material) before the adhesive tape is wound up. Liner materials of this kind are known to the skilled person as release liners or just liners. In addition to the lining of single-sided or double-sided adhesive tapes, liners are also used for lining labels.

Another function of these release liners is to protect the adhesive from contamination prior to use. Furthermore, via the nature and composition of the release materials, release liners can be adjusted such that the adhesive tape can be unwound with the desired force (lightly or heavily). In the case of adhesive tapes coated with adhesive on both sides, the release liners have the additional function of first exposing the correct side of the adhesive on unwind.

A liner, or release liner, is not part of an adhesive tape or label, but only an aid to its production, storage or further processing by diecutting. Moreover, in contrast to a carrier of an adhesive tape, a liner is not joined firmly to a layer of adhesive.

Release liners used industrially are usually paper or film carriers which are furnished with an adhesive coating material (also called a dehesive or non-stick material) in order to reduce the tendency of adhering products to adhere to these surfaces (active release function). As materials of this kind, also referred to as release material, there are a multiplicity of different substances that can be used: waxes, fluorinated or partly fluorinated compounds, and especially silicones, and also various copolymers with silicone components. In recent years, silicones have become extensively established as release materials in the area of adhesive tape application, by virtue of their good processing properties, low costs and broad profile of properties.

A range of adhesive tapes coated on both sides with adhesive are unwound and applied still with the release liner which is present in the product and which lines the second adhesive. In the case of manual application, the adhesive of the adhesive tape is brought into contact with the substrate by running a hand over the release liner. This form of application, carried out with an applied pressure, entails strong contact between the release liner of the adhesive tape and the hand. As a result of the release material used, the release liners employed predominantly have a blunt surface with a high coefficient of friction. In this case, application of the product is unpleasant or even painful, especially when carried out frequently and/or at high speed.

It is known that the coefficient of friction of silicone release coatings can be reduced by various methods, all of which, however, have certain disadvantages.

Unmodified silicone systems, of the kind formed by crosslinking of functionalized siloxanes, have very good release properties, but a high coefficient of friction. When silicone condensation systems are used instead of the silicone addition systems that are predominantly employed industrially, the coefficient of friction is somewhat lower. However, the condensation systems almost exclusively use toxic tin catalysts.

The skilled person is aware that the friction can be lowered by reducing the layer thickness of the release system. At the same time, however, this leads to an often unwanted deterioration in the release properties. The thickness of the release coating can therefore not be reduced ad infinitum; in general, at least full-area covering of the carrier material with the release coating must be ensured. In the case of very open-pored paper carriers, for example, this may result in the need for relatively strong application of the release layer simply for the full-area covering.

The coefficient of friction of release systems can also be lowered by addition of oils or substances which expand the structures formed on crosslinking of the release system. This, however, results in an increase in the proportion of migratable substances within the release system. These substances may deposit on an adhesive which is in contact with the release system, and thereby lower its peel adhesion.

EP 0 903 385 B1 describes the reduction in the friction of radiation-crosslinking silicone systems through addition of spherical silicone particles prepared by controlled hydrolysis of methyltrimethoxysilane. The expensive and inflexible production process prevents the use of porous or hollow additives, such use being particularly advantageous in one aspect of that invention.

U.S. Pat. No. 7,198,854 B describes silicone formulations for the treatment of textile materials for the purpose of reducing friction and producing a shiny appearance. This effect is generated by the addition of a mixture of nylon and particles of silica. The use of silica particles results in an increase in release forces that is undesirable in the adhesive tape sector.

U.S. Pat. No. 5,620,775 A describes articles whose coating contains 20 to 180 μm diameter glass beads in order to improve the reflectivity and friction and to generate a hydrophilic surface.

While 20 μm diameter beads are much too large for application in release films and release papers, the generation of hydrophilic surfaces would result in a marked deterioration in the release characteristics of adhesives.

EP 2 535 389 A1 relates to a release coating composition particularly for furnishing a release liner with a layer composed of the release coating, said composition comprising:
a release agent and
0.01% to 30% by weight (based on the overall composition) of an additive in powder form, in the form of three-dimensional bodies, based on polymers produced from vinyl building blocks.
   The release coating exhibits a low coefficient of friction, although the polymer particles added are being regarded increasingly critically in connection with the introduction of “microplastics” into the environment.

### SUMMARY

It was an object of the present invention to provide release layers which combine a low coefficient of friction with stable, low release values.

A further object of the present invention was to provide release layers which, in applications in adhesive tapes, exhibit only very little or, ideally, no reduction in peel adhesion through transfer of certain components of the release coating to the adhesive after contact.

A further object of the invention was to configure the release layers such that they are toxicologically unobjectionable and as far as possible also satisfy sustainability requirements, particularly with regard to microplastics.

Moreover, the release layers ought to be readily manageable from a process engineering standpoint.

### DETAILED DESCRIPTION

A first and general subject of the invention that achieves these objects is a release coating for furnishing a release liner, said coating comprising
a release agent and
0.01% to 30% by weight, based on the total weight of the release coating, of three-dimensional bodies K,
   and being characterized in that the bodies K comprise a total of at least 90% by weight of one or more polysaccharides.

According to a first advantageous embodiment of the invention, the release coating consists only of the release agent and the three-dimensional bodies K.

A “three-dimensional body” means a three-dimensional, restricted geometric form which can be described by boundary faces. A geometric form is said to be three-dimensional when it is not contained completely in any one plane, and restricted when there is a sphere which completely contains this form.

The best-known bodies possess flat or circular or spherical boundary faces. The bodies K may take the form, for example, of cylinders, cones, spheres, prisms, pyramids, tetrahedra, cubes and/or the five regular polyhedra. When a body is bounded exclusively by planar faces, it is referred to as a polytope or as a restricted polyhedron (multi-faceted body).

In one embodiment, the bodies K may have one or more of the following forms:
parallelepiped, with cuboid and hexahedron (cube) as special instances
prism, with the cylinder as a generalization and with cuboid and hexahedron as special instances
pyramid, with the cone as a generalization and tetrahedron as a special instance
antiprism, with octahedron as a special instance.

The bodies K, especially in the forms recited above, as cubes, for example, preferably have no corners or sharp edges. For this purpose, the corners or edges actually present may be, or may have been, rounded off. The bodies K are preferably ellipsoids, more preferably rotational ellipsoids and more particularly spheres.

With preference in accordance with the invention, the bodies K have a D50 of the volumetric particle size distribution, determined via laser diffraction as described herein, of not more than 15 μm, more preferably not more than 13 μm, more particularly not more than 12 μm. The D90 of the volumetric particle size distribution of the bodies K, determined via laser diffraction as described herein, is preferably not more than 30 μm, more preferably not more than 27 μm, more particularly not more than 25 μm. A “diameter of the bodies K” refers to a straight line which connects two points on the surface of a body and passes through the centre point of that body.

With particular preference
the bodies K are rotational ellipsoids and
the bodies K have a D50 of the volumetric particle size distribution of not more than 12 μm.

With further preference, the length of the smallest diameter of the bodies K differs by not more than 20%, more preferably not more than 10%, from the length of the largest diameter. A “diameter of the bodies K” refers to a straight line which connects two points on the surface of a body and passes through the centre point of that body. As already described, the bodies K are especially preferably spheres. In an ideal sphere, the lengths of the largest and smallest diameters are identical. Minor deviations from the ideal spherical shape do not preclude the epithet “spheres” being assigned to the bodies.

The bodies K may in principle be solid bodies, hollow bodies or porous bodies; preferably they are solid bodies.

In accordance with the invention, the bodies K comprise a total of at least 90% by weight of one or more polysaccharides. The bodies K preferably comprise a total of at least 92% by weight, more preferably a total of at least 95% by weight, more particularly a total of at least 98% by weight of one or more polysaccharides. Especially preferably the bodies K consist of one or more polysaccharides.

The one or the two or more polysaccharides are preferably selected from cellulose and starch. Preferably, therefore, the bodies K comprise a total of at least 90% by weight of one or more polysaccharides selected from cellulose and starch. More preferably the bodies K comprise a total of at least 92% by weight, very preferably a total of at least 95% by weight, more particularly a total of at least 98% by weight of one or more polysaccharides selected from cellulose and starch. Especially preferably the bodies K consist of one or more polysaccharides selected from cellulose and starch.

Particular features of cellulose- and/or starch-based bodies K are that they are readily preparable in the required particle sizes and they are highly stable in silicone systems of the kind frequently utilized as a basis for release coatings. For example, they have proven to be very stable at the temperatures customarily prevailing during the crosslinking of silicone systems, of up to 170° C.

Bodies K comprising starch or consisting of starch are based preferably on starch from potatoes, maize or rice.

Bodies K comprising cellulose or consisting of cellulose preferably comprise what is called microcrystalline cellulose.

In one preferred embodiment of the invention, the bodies K are cellulose or starch spheres having a D50 of the volumetric particle size distribution of not more than 12 μm.

A not insubstantial disadvantage of various conventional, plastics-based release layer additives is that when the release liner is being coated on, the particles partially escape from the release layer system unless they are fixed in the release layer—by crosslinking, for example. “Microplastics” may end up being released in this way. While the three-dimensional bodies K of the present invention may indeed escape from the release layer system, the particles in that case would be toxicologically unobjectionable and biodegradable and are therefore preferable to conventional additives not least from the standpoint of sustainability.

The bodies K are incorporated into the release coating composition preferably with an apparatus selected from the group consisting of paddle stirrer, dispersing disc and in-line dispersing machine, more preferably by means of a dispersing disc or in-line dispersing machine. These two apparatuses are particularly effective at ruling out unwanted agglomeration of the bodies K.

As release agents it is possible in principle to use all of the systems that are known to the skilled person. The release agent is preferably selected from the group consisting of silicones, fluorinated silicones, silicone copolymers, waxes, carbamates and mixtures of two or more of the stated materials.

The release agent may comprise solvent-based and/or solvent-free systems, with solvent-free systems being preferred.

The release agent may be radiation-crosslinking (UV or electron beam), condensation- or addition-crosslinking; preferably it is addition-crosslinking.

The release agent is more preferably a crosslinked silicone. In the as yet uncrosslinked state, therefore, it preferably comprises a mixture of one or more crosslinking catalysts and one or more so-called thermally curable, condensation-crosslinking or addition-crosslinking polysiloxanes. For condensation-crosslinking silicone systems, crosslinking catalysts present in the composition are frequently tin compounds such as dibutyltin diacetate.

Silicone-based release agents based on addition crosslinking can be cured by hydrosilylation. These release agents typically comprise the following constituents:
an alkenylated polydiorganosiloxane, more particularly a linear polymer with terminal alkenyl groups,
a polyorganohydrosiloxane crosslinking agent, and
a hydrosilylation catalyst.

Catalysts which have become established for addition-crosslinking silicone systems (hydrosilylation catalysts) are, in particular, platinum or compounds of platinum such as the Karstedt catalyst (a Pt(0) complex compound), for example.

Further silicone systems used may also be photoactive catalysts, known as photoinitiators, in combination with UV-curable, cationically crosslinking siloxanes on an epoxide and/or vinyl ether basis, and/or UV-curable, radically crosslinking siloxanes such as, for instance, acrylate-modified siloxanes. The use of electron beam-curable silicone acrylates is possible as well. Depending on their intended use, the silicone systems may also include further additions such as stabilizers or flow control assistants.

Photopolymerizable organopolysiloxane compositions can be used as well. Examples include compositions which are crosslinked through the reaction between organopolysiloxanes which have hydrocarbon radicals substituted by (meth)acrylate groups attached directly to the silicon atoms, and in the presence of a photosensitizer (see EP 0 168 713 B1 or DE 38 20 294 C1). Likewise possible for use are compositions in which the crosslinking reaction between organopolysiloxanes which have silicon-bonded, mercapto-group-substituted hydrocarbon radicals and organopolysiloxanes having vinyl groups attached directly to the silicon atoms takes place in the presence of a photosensitizer. Compositions of these kinds are described in U.S. Pat. No. 4,725,630 A1, for example.

When using the organopolysiloxane compositions—described in DE 33 16 166 C1, for example—that have silicon-bonded, epoxy-group-substituted hydrocarbon radicals, the crosslinking reaction is induced by release of a catalytic amount of acid obtained by photodecomposition of onium salt catalysts. Other organopolysiloxane compositions which can be cured by a cationic mechanism are materials which have, for example, propenyloxysiloxane end groups.

In accordance with one particularly advantageous embodiment of the invention, the completely homogenized composition of the release coating is as follows:
92.5% to 99.5% by weight of an addition-crosslinking silicone system based on a vinyl-functionalized polysiloxane, a methylhydrosiloxane and a platinum catalyst; and
0.5% to 7.5% by weight of rotational ellipsoids for which the length of the largest diameter differs by not more than 10% from the length of the smallest diameter, especially spheres, composed of cellulose and/or starch.

A further subject of the invention is the use of a release coating of the invention as at least one outer layer of a release liner or as back-side coating of an adhesive tape carrier. “Outer layer” and “back-side coating” here mean that one side of the layer in question is exposed; in particular, this side is oriented outwardly, i.e. away from the rest of the constituents of the release liner or adhesive tape, and is provided for direct contact with a (pressure-sensitive) adhesive. For this purpose, the release coating of the invention, preferably as a continuous layer, can be applied to a carrier material. A release liner in the context of the use in accordance with the invention is preferably furnished on both sides with a release coating of the invention.

Where the release coating is silicone-based, a release liner or an adhesive tape release-furnished on the back side may be produced by application of the silicone system on which the release coating of the invention is based, solventlessly or from solution, to a carrier, where in principle it is possible to employ all coating techniques that are familiar to the skilled person. Where necessary, the silicone system may subsequently be dried.

The release coating of the invention in the context of the use in accordance with the invention preferably has a layer thickness of 0.1 to 5.0 μm, more preferably of 0.2 to 2.5 μm, more particularly of 0.4 to 2.0 μm.

Carrier material used for the release liner may be, in particular, papers or films. Films in this case are preferably those of biaxially oriented polyethylene terephthalate, polybutene, polypropylene, polyethylene, monoaxially oriented polypropylene, biaxially oriented polypropylene or polyethylene, with particular preference polyolefin films, more particularly polypropylene or polyethylene films, or polyester films.

A further subject of the invention, in accordance with the above, is a release liner which comprises a carrier film and a release coating of the invention.

A further subject of the invention is a single-sidedly adhesively furnished adhesive tape which comprises a carrier material having a first side and a second side and also comprises a pressure-sensitive adhesive on the first side of the carrier material and a release coating of the invention on the second side of the carrier material.

The invention relates, further, to the use of a release coating of the invention, preferably silicone-based, as at least one outer layer of a release liner with which a single-sided or double-sided adhesive tape is lined on one or both sides. Normally a single-sided adhesive tape is lined with a release liner on the adhesive side. In the case of a two-sided adhesive tape, one release liner may be sufficient, or else both adhesive sides may be furnished with one release liner each.

The adhesive present in an adhesive tape is typically, and preferably in accordance with the invention, a pressure-sensitive adhesive. Pressure-sensitive adhesives are adhesives which allow a permanent join to the substrate under just relatively weak applied pressure. At room temperature, pressure-sensitive adhesives are permanently adhesive—that is, they have a sufficiently low viscosity and a high tack, and so they wet the surface of the bond substrate in question even when the applied pressure is low. The bondability of the pressure-sensitive adhesives derives from their adhesive properties, and a more or less strongly pronounced redetachability from their cohesive properties. A variety of compounds are contemplated as a basis for pressure-sensitive adhesives.

The polymer basis of the pressure-sensitive adhesive is preferably selected from the group consisting of poly(meth)acrylates; silicones; natural rubber; and synthetic rubbers, especially styrene block copolymers with an elastomer block composed of unsaturated or hydrogenated polydiene blocks, for example of polybutadiene, polyisoprene, copolymers of both, and other elastomer blocks familiar to the skilled person. The pressure-sensitive adhesive may comprise a combination of two or more base polymers and further to the base polymer or polymers may comprise, for example, tackifier resins, plasticizers, fillers, pigments, UV absorbers, light stabilizers, ageing inhibitors and/or crosslinkers, and also, optionally, further additives.

The carrier or, in the case of what are called adhesive transfer tapes, the liner of the adhesive tape may be coated on one side with the pressure-sensitive adhesive from solution, from dispersion, in 100% form (from the melt, for example) or by coextrusion. An alternative option is that of coating by transfer of a layer of pressure-sensitive adhesive, by lamination. The adhesive layer may be crosslinked by heat or energetic beams.

The coat weight of the layer of pressure-sensitive adhesive is preferably 10 to 120 g/m², more preferably 25 to 100 g/m², this referring to the weight after any necessary removal of water or solvent. The skilled person is aware that the numerical values of the coat weight also correspond in rough approximation to the layer thickness in μm.

A physical pretreatment of the carrier side for coating with the pressure—sensitive adhesive, for the purpose of improving the adhesion, may be advantageous—by flame, plasma or corona treatment, for example. Alternatively or additionally, a primer layer can be applied before the layer of pressure-sensitive adhesive is applied to the carrier, such primer application taking place more particularly solventlessly, such as by coextrusion, for example, to give a primer layer located between the carrier layer and the layer of pressure-sensitive adhesive.

Primers which can be used are the conventional dispersion-based and solvent-based systems, based for example on isoprene- or butadiene-containing rubbers and/or cyclo rubbers. Isocyanates or epoxy resins as additives improve the adhesion and in some cases also increase the shear strength of the pressure-sensitive adhesive.

Another subject of the invention is the use of a release liner of the invention in an adhesive tape used for joining paper or film webs.

Flat materials in web form, paper in particular, in industry are frequently wound up to form bales, which are then supplied, for example, to paper-processing machines or to printing and/or packaging machines. In ongoing operation of such lines, it is necessary to attach the start of a new, wound bale to the end of a first bale of the flat material in web form, and to join the start and end in a suitable way, in a switch made on the fly, without having to stop the high-speed machines for the switch of rolls. This operation is referred to as splicing.

For this purpose, within the paper industry, double-sided adhesive tapes are used which consist essentially of a carrier layer and two layers of pressure-sensitive adhesive, in order to produce a bond between the end of the old material web and the start of the new material web. The end of the old material web is bonded in this case to the start of the new material web.

The general expression “adhesive tape” for the purposes of this invention encompasses all sheetlike structures such as two-dimensionally extended webs or web portions, tapes with extended length and limited width, tape portions, labels, diecuts and the like.

Release coatings of the invention enable the provision of release liners or release-furnished adhesive-tape back sides with a significantly lower coefficient of friction by comparison with the same system without the bodies K that are present in accordance with the invention. These additives effectively reduce the friction of the release coatings while retaining the good release properties with respect to a variety of adhesives.

It has emerged, furthermore, that the bodies K present in the release coating in accordance with the invention also reduce the depression of peel adhesion of a pressure-sensitive adhesive covered with the release system in the context of solvent-based silicone release systems on film carriers. At least in the fractional range from 1% to 8% by weight of bodies K, a distinct decrease in the depression of peel adhesion has been observed as the fraction goes up. A further subject of the invention, therefore, is a release liner which comprises a carrier film and a solvent-based release coating, with the release coating comprising a release agent and 1% to 8% by weight, more preferably 2% to 6% by weight, based in each case on the total weight of the release coating, of three-dimensional bodies K and with the bodies K comprising at least 90% by weight of one or more polysaccharides. All of the configuration forms of the release coating of the invention or of the release liner of the invention that are described herein, provided they can be employed for the release liner described in this paragraph, are also preferable for this release liner. In particular, the material of the carrier film for the release liner described here is selected from the group consisting of biaxially oriented polyethylene terephthalate; polybutene, polypropylene, especially monoaxially oriented polypropylene and biaxially oriented polypropylene; and polyethylene. The material of the carrier film is especially preferably monoaxially oriented polypropylene (MOPP).

“Solvent-based release coating” or “solvent-based silicone release system” means that the release system in question is applied as an actually solvent-containing system, although, after the crosslinking, which is generally initiated thermally, only traces at most of the solvent are present in the release system. The skilled person nevertheless refers to this as a “solvent-based system” or else “solvent-containing system” and thereby characterizes the specific properties of a release coating obtained on a solvent basis in this way.

### EXAMPLES

Unless otherwise indicated, all fractions of components below are reported in each case relative to their weight.

### Production and Coating of the Release Systems

Release liners were produced on KSC 950 white paper (from UPM) with a width of 1300 mm by using a laboratory coating line to apply the release system formulations indicated below, with and without additions of additives. The additives were incorporated into the compositions by stirring using a paddle stirrer. After coating, the release systems were crosslinked in a forced-air oven at 160° C. for 30 s.

The liners produced in this way were investigated for their coefficient of friction, the release value relative to the test adhesive tapes Tesa® 7475 and Tesa® 50110, and the depression of peel adhesion. The test tape Tesa® 7475 is a PVC carrier 40 μm thick, coated with 95 g/m² of a resin-modified pressure-sensitive acrylate adhesive. The test tape Tesa® 50110 is 300 μm thick and uses a pressure-sensitive natural rubber adhesive on a fabric carrier.

### Measurement of the Release Characteristics

Strips of the test tapes Tesa® 7475 and Tesa® 50110, each with a width of 20 mm and a length of 300 mm, were adhered to the release liners. For each sample, 3 laminates of liner with test tape Tesa® 7475 and liner with test tape Tesa® 50110 were stored under pressure and temperature for 24 h. The temperature during storage was 40° C. for the test tape Tesa® 50110 and 70° C. for the test tape Tesa® 7475. The pressure in both cases was 4 N/cm².

After the subsequent storage of the samples for 2 hours in a controlled-climate measuring chamber at 23° C. and 50% relative humidity, the release force was determined by means of a Zwick tensile testing machine. The peel velocity was 300 mm/min, the peel angle 180°. The result reported in each case is the average from the measurements of the three laminates.

### Measurement of the Depression of Peel Adhesion

In addition, possible transfer of silicone or of the various additives was evaluated by measuring the depression of peel adhesion of the test tape Tesa® 7475. For this purpose, the peel adhesion of a new Tesa® 7475 test tape on a steel surface was measured by means of a tensile test (Zwick tensile testing machine, 300 mm/min, 180°).

Subsequently a Tesa® 7475 test tape which had been stored beforehand with the liner at pressure and temperature for 24 h, for the measurement of the release characteristics, was likewise adhered to steel, and the peel adhesion was measured with a tensile test. The depression of peel adhesion (PA) is calculated according to the following formula:

$$\\ Depression of peel adhesion = \frac{( PA of fresh tape - PA of tape in contact with liner )}{PA of fresh tape} * 100 \%$$

### Measurement of the Silicone Add-on

The coat weight of the release system was determined via X-ray fluorescence analysis. For this purpose, the carrier coated with the release system under investigation is analysed using the Lab-X³⁰⁰⁰ X-ray fluorescence analyser from Oxford with an internal (polydimethylsiloxane) reference. Following excitation by X-radiation, energy released is detected in the form of Si-specific fluorescent radiation and converted stoichiometrically by the instrument into the coat weight of the silicone release system in g/m². Any extraneous detections arising from additives in the carrier material are accounted for through determination of a blank value.

### Determination of the Application Characteristics

To resolve the issue of whether the release system exhibits a pleasant sensation on the skin during application, the samples coated with release system were evaluated in a direct comparison by five human testers. The basis for the evaluation is the skin sensation when the liner coated with release system is applied with the hand under relatively strong pressure—that is, the customary methods known to the skilled person for the application of pressure-sensitive adhesives. The only distinction made was between
1=pleasant and
2=unpleasant.

### Silicone System

The silicone system A is an addition-crosslinking silicone system from Wacker. 9.75 g of DEH 915 (a polydimethylsiloxane functionalized with vinyl groups) were mixed with 0.33 g of V24 (a methylhydrogenpolysiloxane) and 0.08 g of Kat OL (a platinum catalyst also known under the name “Karstedt catalyst”).

The silicone system provided for coating the outer sides of the liners was admixed in each case with 2.5% by weight of PMMA spheres (Sepimat® SB, SEPPIC, solid spheres with a size of 1 to 5 μm) or of starch spheres (Sepifine® BB, SEPPIC, solid spheres, D50 of the particle size distribution has a value of 11 μm); the systems intended for the inner sides of the liners received no further addition. The mixtures were homogenized, applied to the carrier and then crosslinked as described above.

### Determination of the Particle Size Distribution

The particle size distribution was undertaken via laser diffraction with the “Bettersizer S3 Plus” instrument. The dispersing medium utilized was fully demineralized water. The sample was placed directly into the dispersing unit filled with fully demineralized water. Prior to the measurement, the sample was exposed to the instrument's internal ultrasound (35 W), which was also active during the measurement. The stirring speed was 1200 rpm. Evaluation took place by the Mie method with the instrumentally determined refractive index RI 1.50-0.01i.

TABLE 1
Add-on of the silicone system, results

| No. | Side | Additive |
|---|---|---|
| 1 | outer | Sepifine |
| 1 | inner | — |
| 2 | outer | Sepimat |
| 2 | inner | — |

| | | Surface weight of silicone add-on (g/m²) | | | | | |
|---|---|---|---|---|---|---|---|
| | | | | | | Blank | Coat |
| No. | Side | Right | Middle | Left | Average | value | weight |
| 1 | outer | 2.4 | 2.2 | 2.3 | 2.3 | 0.5 | 1.8 |
| 1 | inner | 2.2 | 1.9 | 1.9 | 2.0 | 0.2 | 1.9 |
| 2 | outer | 2.4 | 2.5 | 2.5 | 2.4 | 0.5 | 2.0 |
| 2 | inner | 2.1 | 2.2 | 2.2 | 2.2 | 0.2 | 2.0 |

TABLE 2
Results

| | | Release | Release | | |
|---|---|---|---|---|---|
| | | force | force | Depression | |
| | | 7475 | 50110 | of peel | Application |
| No. | Side | (cN/cm) | (cN/cm) | adhesion (%) | characteristics |
| 1 | outer | 4 | 8 | 0 | 5 × 1 |
| 1 | inner | 5 | 11 | 4 | |
| 2 | outer | 4 | 11 | 6 | 5 × 1 |
| 2 | inner | 4 | 10 | 6 | |

1. A release coating for furnishing a release liner, the release coating comprising
a release agent; and
0.01% to 30% by weight, based on the total weight of the release coating, of three-dimensional bodies K,
wherein, the bodies K comprise a total of at least 90% by weight of one or more polysaccharides.

2. The release coating of claim 1, wherein the bodies K are ellipsoids.

3. The release coating of claim 1, wherein the bodies K have a D50 of the volumetric particle size distribution, determined via laser diffraction as described herein, of not more than 15 μm.

4. The release coating of claim 1, wherein
the bodies K are rotational ellipsoids; and
the bodies K have a D50 of the volumetric particle size distribution of not more than 12 μm.

5. The release coating of claim 1, wherein the release coating comprises a total of 0.1% to 10% by weight, based on the total weight of the release coating, of the bodies K.

6. The release coating of claim 1, wherein the bodies K are solid bodies.

7. The release coating of claim 1, wherein the bodies K comprise at least 90% by weight of cellulose and/or starch.

8. The release coating of claim 1, wherein the release agent is selected from the group consisting of silicones, fluorinated silicones, silicone copolymers, waxes, carbamates and mixtures of two or more of the stated materials.

9-12. (canceled)

13. The release coating of claim 1, wherein
the release agent consists of an addition-crosslinked silicone system based on a vinyl-functionalized polysiloxane, a methylhydrosiloxane, and a platinum catalyst,
the release agent is 92.5% to 99.5% by weight of the release coating,
the three-dimensional bodies K consist of rotational ellipsoids made of cellulose, starch, or both cellulose and starch, and
the three-dimensional bodies K are 0.5% to 7.5% by weight of the release coating.

14. The release coating of claim 1, wherein
the release agent comprises an addition-crosslinked silicone system formed by crosslinking an alkenylated polydiorganosiloxane in the presence of a polyorganohydrosiloxane crosslinking agent and a hydrosilylation catalyst.

15. The release coating of claim 14, wherein
the alkenylated polydiorganosiloxane comprises a linear polydiorganosiloxane with terminal alkenyl groups.

16. The release coating of claim 14, wherein
the polyorganohydrosiloxane comprises a methylhydrogenpolysiloxane.

17. The release coating of claim 14, wherein
the three-dimensional bodies K consist of rotational ellipsoids made of cellulose, starch, or both cellulose and starch.

18. A release liner comprising:
a release carrier comprising two sides; and
a release coating disposed on at least one of the two sides of the release carrier, the release coating comprising:
a release agent; and
0.01% to 30% by weight, based on the total weight of the release coating, of three-dimensional bodies K,
wherein, the bodies K comprise a total of at least 90% by weight of one or more polysaccharides.

19. The release liner of claim 18, wherein
the release coating comprises a layer thickness within a range of from 0.1 μm to 5.0 μm.

20. The release liner of claim 18, wherein
the carrier is a paper or film.

21. The release liner of claim 18, wherein
the release agent is a crosslinked silicone system.

22. The release liner of claim 18, wherein
the release agent consists of an addition-crosslinking silicone system based on a vinyl-functionalized polysiloxane, a methylhydrosiloxane, and a platinum catalyst,
the release agent is 92.5% to 99.5% by weight of the release coating,
the three-dimensional bodies K consist of rotational ellipsoids made of cellulose, starch, or both cellulose and starch, and
the three-dimensional bodies K are 0.5% to 7.5% by weight of the release coating.

23. An adhesive tape comprising:
an adhesive carrier comprising a first side and a second side;
a pressure-sensitive adhesive disposed on the first side of the adhesive carrier; and
a release liner comprising:
a release carrier comprising two sides; and
a release coating disposed on at least one of the two sides of the release carrier, the release coating comprising:
a release agent; and
0.01% to 30% by weight, based on the total weight of the release coating, of three-dimensional bodies K, wherein, the bodies K comprise a total of at least 90% by weight of one or more polysaccharides.

24. The adhesive tape of claim 23, wherein
the release agent consists of an addition-crosslinking silicone system based on a vinyl-functionalized polysiloxane, a methylhydrosiloxane, and a platinum catalyst,
the release agent is 92.5% to 99.5% by weight of the release coating,
the three-dimensional bodies K consist of rotational ellipsoids made of cellulose, starch, or both cellulose and starch, and
the three-dimensional bodies K are 0.5% to 7.5% by weight of the release coating.
